(19) United States
(12) Patent Application Publication
(10) Pub. No.: US 2003/0201987 A1
(43) Pub. Date: Oct. 30, 2003

(54) Device and method for adjusting inverted image in display system

(75) Inventors: Seung-A Nam, Kumi-shi (KR); Chae-Whan Lim, Taegukwangyok-shi (KR)

Correspondence Address: Paul J. Farrell, Esq., DILWORTH & BARRESE, LLP, 333 Earle Ovington Blvd, Uniondale, NY, 11553, US

(73) Assignee: SAMSUNG ELECTRONICS CO., LTD., KYUNGKI-DO (KR)

(21) Appl. No.: 10/423,564

(22) Filed: Apr. 24, 2003

(30) Foreign Application Priority Data
Apr. 25, 2002 (KR) 2002-22815
Aug. 1, 2002 (KR) 2002-45540

(51) Int. Cl. G09G 5/00

(52) U.S. Cl. 345/204

(57) ABSTRACT

An image display system of a portable telephone is disclosed. The image display system comprises: a key pad provided with keys for setting a photographing mode and a screen displaying mode; a camera for capturing an image signal; a signal processing unit for converting the image signal outputted from the camera into image data and outputting it; a display unit for displaying the image data received from the signal processing unit; a side key for setting normal image data when the image data is displayed as an inverted image on the display unit; an image processing unit for transmitting the image data received from the signal processing unit and an address value where the image data starts to be outputted to the display unit, wherein, at the time when the side key is inputted, the image processing unit changes the address value where the image data starts to be outputted and transmits it to the display unit; and a control unit for generating a photographing control signal at the time when the photographing mode key is inputted, wherein, at the time when the side key is inputted, the control unit controls the image processing unit to change the address value where the image data starts to be outputted and to transmit it to the display unit.

### PRIORITY

This application claims priority to applications entitled “Device and Method for Adjusting Inverted Image in Display System” filed in the Korean Industrial Property Office on Apr. 25, 2002 and assigned Ser. No. 2002-22815 and filed on Aug. 1, 2002 and assigned Ser. No. 2002-45540, respectively, the contents of which are hereby incorporated by reference herein.

### BACKGROUND OF THE INVENTION

1. Field of the Invention

The present invention relates to a device and method for adjusting an inverted image of an image display system, and more particularly to a device and method for adjusting the condition in which image data photographed by a camera is outputted to the display unit as an inverted image.

2. Description of the Related Art

In general, an image display system comprises a camera for photographing an image, and a display unit for displaying the image signal photographed by the camera. Herein, a CCD sensor may be used in the camera, and an LCD may be used in the display unit. It is common for there to be provided such a camera in a portable telephone. The portable telephone can photograph an image and display it as a moving picture and as a still picture. The portable telephone can also transmit the image screen.

In such an image display system as described above, however, the image captured through the camera can be displayed as an inverted image when it is displayed on the display unit of the image display system.

For example, when a user views his or her own appearance displayed on the display unit in order to photograph his or her own appearance while using a camera lens, normal image data may be outputted. However, when the user photographs a person or an object in front of the user, the user turns the camera lens rearward to be directed to the person or the object and views the image data photographed by the camera from the display unit. Upon photographing in this manner, a problem is caused in that the image data outputted to the display unit is displayed as an inverted image relative to the user.

### SUMMARY OF THE INVENTION

Accordingly, the present invention has been made to solve the above-mentioned problems occurring in the prior art, and an object of the present invention is to provide a device and method for adjusting inverted image data appearing in a display unit, when an image is photographed by a camera in an image display system and displayed as an inverted image on the display unit.

In order to accomplish this object, there is provided an image display system for a portable telephone comprising: a key pad provided with keys for setting a photographing mode and a screen displaying mode; a camera for capturing an image signal; a signal processing unit for converting the image signal outputted from the camera into image data; a display unit for displaying the image data received from the signal processing unit; a side key for displaying the image data as an inverted image on the display unit; an image processing unit for transmitting the image data received from the signal processing unit and a starting address value where the image data starts to the display unit, wherein the image processing unit changes the address value where the image data starts and transmits it to the display unit when the side key is inputted; and a control unit for generating a photographing control signal at the time when the photographing mode key is inputted, wherein the control unit commands the image processing unit to change the starting address value where the image data starts to be outputted and to transmit it to the display unit when the side key is inputted.

In accordance with another aspect of the present invention, there is also provided a method for displaying an image in a portable telephone comprising the steps of: capturing an image with a camera; transmitting a command, which informs a display unit of a starting address of the image data which is outputted; transmitting the image data captured by the camera; outputting the image data to the display unit from the starting address; judging whether the image data outputted to the display unit is displayed as an inverted image; operating a side key when the image data outputted to the display unit is displayed as an inverted image; transmitting a command for the image data to be outputted in an inverse sequence; transmitting a command, which informs the display unit of a revised starting address of the image data which is outputted; transmitting the image data captured by the camera; and outputting the image data from the revised starting address in the inverse sequence.

In order to accomplish the above object, the present invention also provides a method for displaying an image in a portable telephone comprising the steps of: capturing an image with a camera; designating a starting address of the image data outputted to a display unit; initializing a column counter value and a line counter value; transmitting the image data captured by camera to the display by increasing the column counter value until the column counter becomes a maximum value, and increasing the line counter value by one and re-initializing the column counter when the column counter value becomes a maximum value, wherein this procedure is repeated until both the column counter value and the line counter value become maximum values; initializing the column counter value and the line counter value and terminating the outputting of the image data and displaying the image data in the display unit when both of them become maximum values; judging whether the image data outputted to the display unit is displayed as an inverted image; operating a side key when the image data outputted to the display unit is displayed as an inverted image; changing and designating the starting address of the image data outputted to the display unit; initializing the column counter value to a minimum value and the line counter value to a maximum value; transmitting the image data captured by the camera to the display by increasing the column counter value until the column counter becomes a maximum value and decreasing the line counter value by one and re-initializing the column counter when the column counter value becomes the maximum value, wherein this procedure is repeated until the column counter value becomes the maximum value and the line counter value becomes the minimum value; and initializing the column counter value and the line counter value, terminating the outputting of the image data and displaying image data on the display unit when the column counter value becomes the maximum value and the line counter value becomes the minimum value.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a construction of an image displaying system in accordance with an embodiment of the present invention, which variably displays an image depending on the light level of surroundings;

FIG. 2 illustrates a construction of a signal processing unit in accordance with an embodiment of the present invention;

FIG. 3a illustrates a construction of an image processing unit in accordance with the first embodiment of the present invention;

FIG. 3b illustrates a construction of an image processing unit in accordance with the second embodiment of the present invention;

FIG. 4 is a flowchart illustrating a method for transmitting image data to a display unit of a portable telephone in accordance with the first embodiment of the present invention;

FIG. 5 is a flowchart illustrating a method for transmitting image data to a display unit of a portable telephone in accordance with the second embodiment of the present invention; and

FIG. 6 illustrates an aspect for adjusting an inverted image displayed on the display unit of the portable telephone in accordance with the first and second embodiments of the present inventions.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention less clear.

It shall be noted that like constituent elements are indicated by like identical reference numerals throughout the following description.

In the following description, a portable telephone will be described as an example of a photographing and display system in accordance with the present invention. However, the present invention can be identically applied to a portable communication system that displays an image using a camera, beyond such a portable telephone.

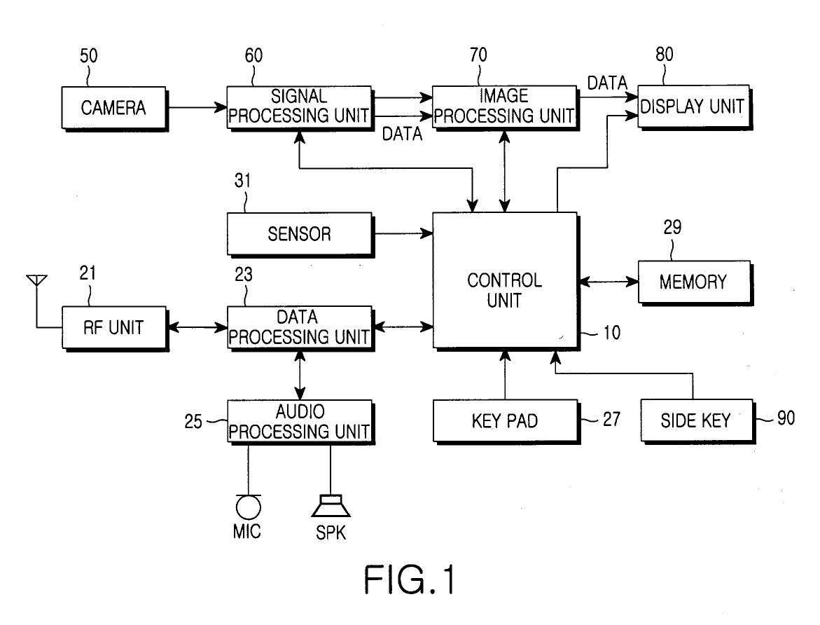

FIG. 1 illustrates a construction of an image processing device in accordance with an embodiment of the present invention, which may be a portable telephone.

Referring to FIG. 1, an RF unit 21 performs the communication of a portable telephone. The RF unit 21 comprises an RF transmitter for up-converting and amplifying the frequency of a transmitted signal, and an RF receiver for performing low noise amplification of a received signal and down-converting its frequency. A data processing unit 23 comprises a transmitter for coding and modulating the transmitted signal and a receiver for decoding and demodulating the received signal. That is, the data processing unit 23 may consist of a MODEM and a CODDEC. An audio processing unit 25 functions to reproduce a received signal outputted from the data processing unit 23 via speaker (SPK) or to transmit an audio signal, which is generated from a microphone (MIC), to the data processing unit 23.

A key pad 27 is provided with keys for inputting digits and character information and function keys for setting various functions. According to an embodiment of the present invention, the key pad 27 may also include a mode setting key, a photographing key or the like for performing photographing and displaying functions depending on the light level of surroundings.

A memory 29 may consist of a program memory and a data memory. The program memory can store programs for controlling common operations of portable telephones and for controlling a path for an image signal applied to display unit according to an embodiment of the present invention. Also, the data memory functions to temporarily store data, which is generated while said programs, are performed.

A control unit 10 functions to control entire operations of a portable telephone. The control unit 10 may also include the data processing unit 23. Furthermore, according to an embodiment of the present invention, the control unit 10 controls the signal processing unit 60 to set a photographing mode when the mode setting is changed by means of the key pad 27, and to display a photographed image data in accordance with the set photographing mode. In addition, the control unit 10 controls a path for transmitting image data to a display unit 80 in accordance with an embodiment of the present invention, and at the time of operating a side key, controls an image processing unit 70 to change a starting address value of the image data which is outputted from the display unit.

A camera 50 photographs an image and comprises a camera sensor for converting the photographed image data into an electric signal. Herein, it is assumed that the camera sensor is a charged coupled device (CCD) sensor.

The signal processing unit 60 converts the image signal, which is outputted from said camera 50, into digital image data. Herein, the signal processing unit 60 can be realized by a digital signal processor (DSP). The image processing unit 70 functions to produce display screen data for displaying the image signal outputted from the signal processing unit 60.

The image processing unit 70 transmits an image signal received under the control of the control unit to meet the specification of the display unit 80 and also functions to compress and expand the image data. It also transmits the starting address value of the image data outputted to the display unit 80 or to transmit the starting address value after changing and setting it under the control of the control unit 10.

The display unit 80 receives the image data from the starting address value, which is outputted from the image processing unit 70, and then displays it on the screen. Herein, the display unit 80 may employ a liquid crystal device (LCD), in which case the display unit 80 may be provided with an LCD controller, memory data that can store the image data, and an LCD display device. Herein, if the LCD is embodied by a touch screen, the key pad 27 may serve as an input unit. The display unit 80 includes an image data display unit, from which the image data is outputted.

When the image data outputted onto the display unit 80 is displayed as an inverted image, the side key 90 is operated by a user, so that normal image data is displayed on the display unit 80 under additional processing control of the control unit 10.

The operation of a portable telephone is described with reference to FIG. 1. At the time of calling, if a user executes a dialing operation and then sets an origination mode through the key pad 27, the control unit 10 senses it, processes the dial information received using the data processing unit 23 and then outputs the information after it is converted into an RF signal through the RF unit 21. If a called subscriber generates a response signal, it is sensed through the RF unit 21 and the data processing unit 23. An audio communication path is formed through the audio processing unit 25, so that the voice communication function can be performed. In addition, at the time of destination mode (incoming call, for example), the control unit 10 senses the destination mode through the data processing unit 23 and then generates a ring signal through the audio processing unit 25. Thereafter, if the user answers, the control unit 10 senses it and a path for audio communication is also formed, so that the voice communication function can be performed. Although the origination and destination modes are described in connection with the audio communication as an example in the above, it is possible to perform a data communication function for communicating packet data and image data, in addition to the audio communication. In addition, when a waiting mode or character communication is performed, the control unit 10 displays character data, which is processed through the data processing unit 23, on the display unit 80.

A portable telephone can also perform operations for photographing a person or surroundings and displaying or transmitting such a photograph to an image screen. First, the camera 50 may be mounted in a portable telephone or connected to a predetermined position in the exterior of the portable telephone. That is, the camera 50 may be either an external camera or an internal camera.

The camera 50 may employ a charge coupled device (CCD) sensor. An image photographed by the camera 50 is converted into an electric signal by the CCD sensor within the camera and then provided to the signal processing unit 60. Then, the signal processing unit 60 outputs the image signal to the image processing unit 70 after converting it into a digital image data.

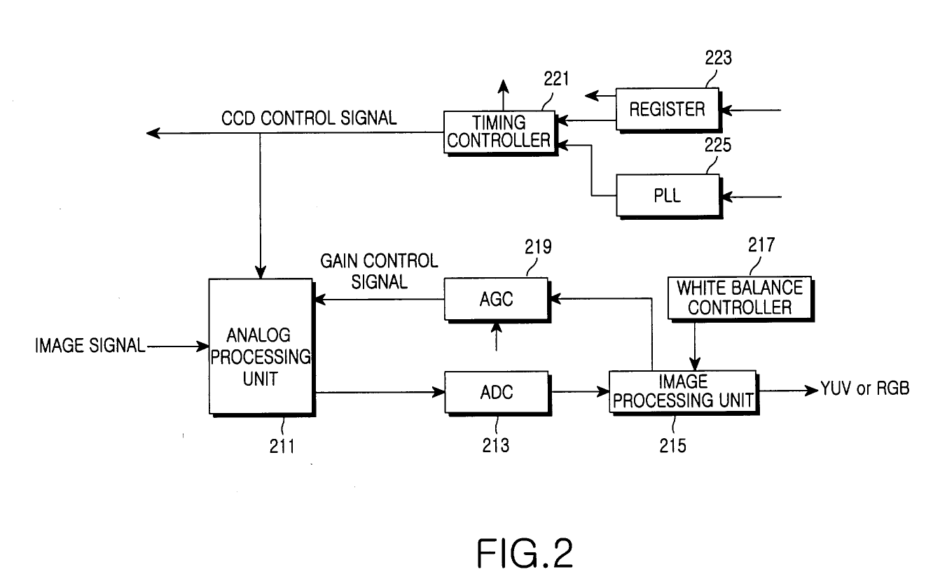

FIG. 2 shows the construction of the signal processing unit 60 of FIG. 1.

Referring to FIG. 2, an analog processing unit 211 is inputted with an analog signal outputted from the camera 50 and functions to control the amplification the image signal based on a gain control signal. An analog to digital converter (ADC) 213 converts the analog signal outputted from the analog processing unit 211 into a digital data and outputs it. Herein, the ADC 213 may be 8-bit ADC. The output of the ADC 213 is inputted into an image processing unit 215, and the processing unit 215 converts the image data into a YUV or RGB data and outputs it. The image processing unit 215 comprises a line memory or a frame memory within it and functions to output the processed image data in a line unit or frame unit. A white balance controller 217 adjusts the white balance of light. An automatic gain controller 219 generates a gain control signal for controlling the gain of image signal and functions to output the generated gain control signal to the analog processing unit 211.

A register 223 stores control data outputted from the control unit 10. A phased locked loop (PLL) 225 functions to generate a reference clock for controlling the operation of the signal processing unit 60. A timing controller 211 is inputted with the reference clock outputted from the PLL 225 and generates timing control signals for controlling the operation of the signal processing unit 60.

Herein, considering the operation of the signal processing unit 60, the camera 50 comprises a CCD sensor, which converts an optical signal captured from image-photographing into an electric signal and outputs it. Then, the analog processing unit 211 processes the optical signal received from the camera 50. In addition, the analog processing unit 211 controls the gain of the image signal by means of a gain control signal from AGC 219. The ADC 213 converts the analog image signal outputted from the analog processing unit 211 into a digital image data and then outputs it to image processing unit 215. The image processing unit 215 comprises a memory for storing image data and outputs the digital image data after converting it into RGB or YUB image data. The memory for storing the image data may be embodied by a line memory for storing image data of line unit or a frame memory for storing image data of frame unit. It is assumed that the line memory is used in the embodiment of the present invention. It is also assumed that the image processing unit 215 in accordance with the embodiment of the present invention converts the digital image data into YUV data.

The white balance controller 217 generates a control signal for tuning the white balance of the photographed image signal, and thus adjusts the white balance the processed image data. The automatic gain controller (AGC) 219 generates a signal for controlling the gain of the image signal received by the CCD control signal and applies it to the analog processing unit. The register 223 stores the control data outputted from the control unit 10. The PLL 225 generates a reference clock, which is used by the signal processing unit. The timing controller 221 generates various control signals based on the reference clock outputted from the PLL 225 that are used to synchronize the CCD and analog processing unit 211.

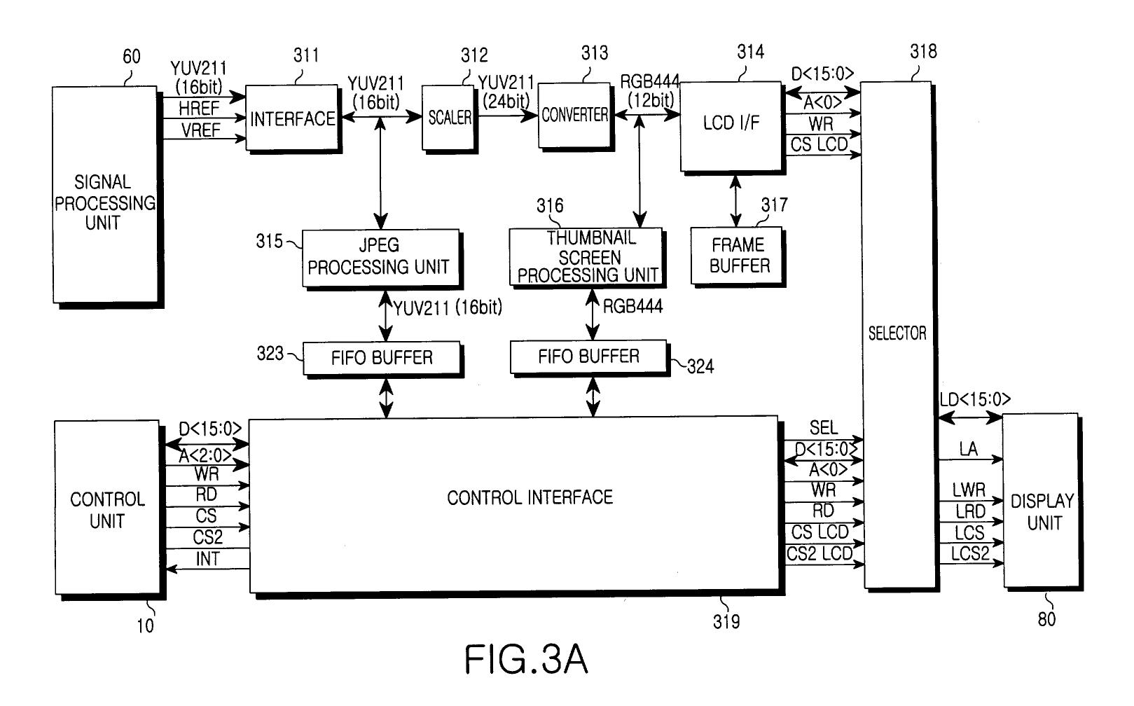

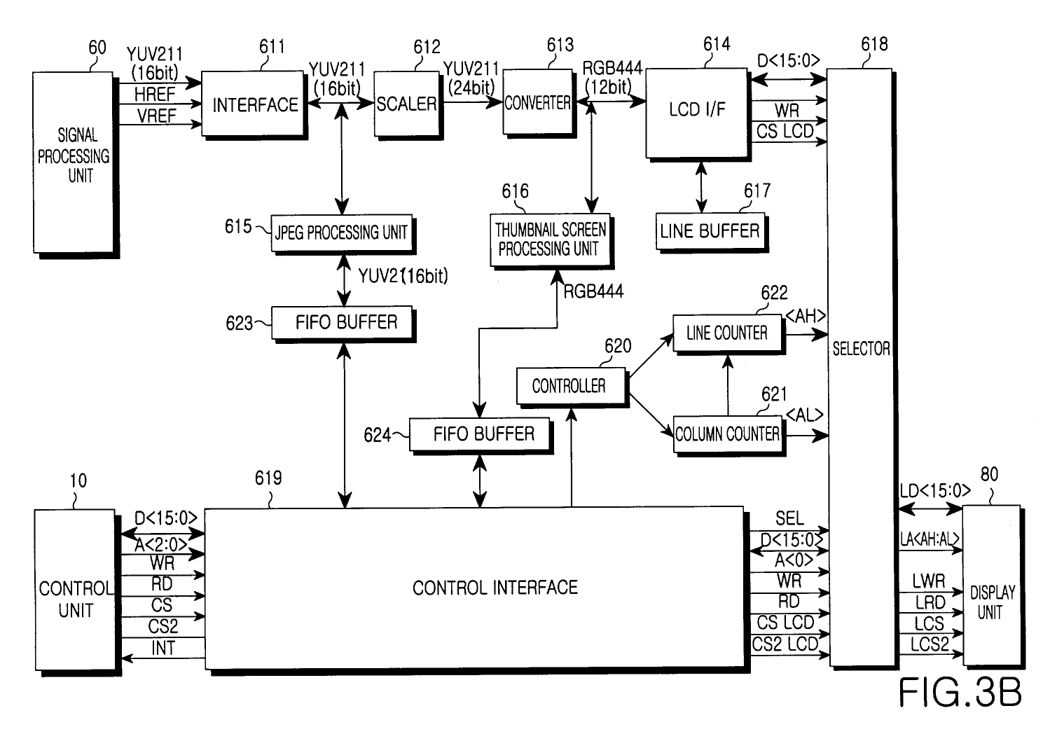

FIGS. 3a and 3b shows the construction of the image processing unit in accordance with an embodiment of the present invention.

Referring to FIGS. 3a and 3b, the image processing unit 70 functions to interface with the signal processing unit 60 as well as to compress and expand an inputted image signal to a JPEG format. It also functions to decimate and crop the pixels and lines of compressed image data in the main screen, and to generate a thumbnail screen.

Referring to FIG. 3a, the image processing unit 70 in accordance with the first embodiment has functional units constructed as follows:

The image processing unit 70 comprises a camera interface 311 (hereinafter, to be referred as “CCD interface”), a scaler 312, a converter 313, a display interface 314 (hereinafter, to be referred as “LCD interface”), and a frame buffer 317. The image processing unit functions to interface image data between the camera 50 via the signal processing unit 60 and the display unit 80.

In general, the number of pixels of image data in one screen outputted from the camera 50 and the number of pixels of image data of one screen displayed on the display unit 80 are different. Therefore, the image processing section functions to interface image data between the camera 50 and the display unit 80.

In the image processing unit, the LCD interface 314 can access the control unit 10 and the image data of the image processing unit by the switching of a selector 318. In the drawing, LD<15.0> is a data bus for the LCD of Display Unit 80, its direction is set by the output of RD/WR (when LRD is asserted). A is an address signal, CS is a select signal of the display unit, WR is a write signal, and RD is a read signal. LWR, LA, LRD, and LCS are the corresponding signals driven on the LCD/Display unit 80 side.

The frame buffer 317 functions to buffer the image data interfaced with the display unit 80 in the LCD interface 314. The JPEG processing unit 315 functions to compress the image data outputted from the signal processing unit and then to output it via FIFO buffer 323 and control interface 319 into the control unit 10 as a coded data for storage, or functions to expand the coded data inputted via FIFO buffer 323 and control interface 319 from the control section 10 and then to output image data to the image processing unit.

That is, when JPEG data that is previously stored is to be decompressed, control unit 10 transmits the JPEG data to JPEG processing unit 315, which decompresses the data and reconstructs a frame of the image. The image frame is then transmitted into the image processing unit, where it is processed by scaler 312, converter 313 and LCD I/F 314. The image passes through selector 318 for display via the LCD of display unit 80.

A thumbnail screen processing unit 316 comprises a thumbnail resizer and a thumbnail buffer. The thumbnail screen processing unit functions to reconstruct image data, which is outputted from the image processing unit, in the established thumbnail screen. Image data of the thumbnail screen is generated by withdrawing previously stored JPEG data from control unit 10, which is transmitted via control interface 319 and FIFO buffer 324 to thumbnail screen processing unit 316. Thumbnail screen processing unit 316 decompresses the JPEG data and further conditions the thumbnail image, which is then transmitted into image processing unit via LCD I/F 314 for display of the thumbnail image by display unit 80. Alternatively, the created thumbnail image may again be compressed by thumbnail screen processing unit 316 and re-stored in control unit 10.

The control interface 319 functions as an interface between the image processing unit 70 and the control unit 10, and also functions as an interface between the display unit 80 and the control unit 10. The control interface 319 is a common interface for accessing the register within the image processing unit 70, accessing the JPEG buffer and the thumbnail buffer, and accessing the display unit 80 through the image processing unit 70. D<15:0> is a data bus, A<1:0> is an address bus, and CS is a select signal of the image processing unit 70 and the display unit 80. Also, WR is a write signal, RD is a read signal, and SEL is a path control signal of the selector 318. INT is a signal notifying control unit 10 of completion of transfer of a frame of data from signal processing unit to LCD I/F 314. The selector 318 functions to select the data outputted from the image processing unit 70 or the data outputted from the control unit 10 by the path control signal and to output the selected one to the display unit 80. Herein, a first path control signal activates a bus between the image processing unit and the display unit 80 and a second activates a path between the control unit and the display unit 80. This may be achieved by appropriately setting a register (not shown) in control interface 319, the register being addressed by address bus A<2:0>. In addition, the control unit 10 can perform bi-directional communication with the display unit 80 via the selector 318.

In the image processing unit, the operation of the camera 50 for capturing image data and the operation for displaying the captured image data in the image processing unit will be described.

Firstly, it will be described how the image data captured by the camera 50 is transferred to the display unit 80.

The image processing unit 70 controls the transmission rate of the image data outputted from the signal processing unit 60 and stores the inputted image data in the memory of the display unit through the LCD interface 314. The transmission rate of the image data is fixedly determined in reference to a master clock but the flow of the image signal to the signal processing unit 60, the image processing unit 70 and the display unit 80 is limited by the access speed of the display unit 80. Therefore, in order to adjust the read speed of the image signal from the signal processing unit 60 and the write speed of the image signal to the display unit 80, the LCD interface 314 temporarily performs buffering through the frame buffer 317.

Referring to FIG. 3b, the image processing unit 70 in accordance with the second embodiment has functional units constructed as follows:

The image processing unit comprises a camera interface 611 (hereinafter, to be referred as “CCD interface”), a scaler 612, a converter 613, a display interface 614 (hereinafter, to be referred as “LCD interface”), and a line buffer 617. The image processing unit functions to interface image data between the camera 50 and the display unit 80.

In general, the number of pixels of image data in one screen outputted from the camera 50 and the number of pixels of image data of one screen displayed on the display unit 80 are different. Therefore, the image processing section functions to interface image data between the camera 50 and the display unit 80.

In the image processing unit, the LCD interface 614 can access the control unit 10 and the image data of the image processing unit by the switching of a selector 618. In the drawing, LD<15:0> is a data bus, its direction is set by an output, not including the data read from the display unit 80 (when LRD is asserted). LA is an address signal, CS is a select signal of the display unit, WR is a write signal, and RD is a read signal.

The line buffer 617 functions to buffer the image data interfaced with the display unit 80 in the LCD interface 614. In an analogous manner to that described for FIG. 3A, the JPEG processing unit 615 functions to compress the image data outputted from the signal processing unit and then to output it through FIFO buffer 623 and control interface 619 into the control unit 10 as coded data, or functions to expand the coded data inputted from the control section 10 and then to output it to the image processing unit at scaler 612.

A thumbnail screen processing unit 616 comprises a thumbnail resizer and a thumbnail buffer. The thumbnail screen processing unit functions to reconstruct image data, which is outputted from the image processing unit, in the established thumbnail screen. The thumbnail screen processing unit 616 and related processing is performed analogous to the description above with respect to FIG. 3A.

A column counter 621 and a line counter 622 increase and reduce image data formed of pixels to a column and line under the control of a controller 620 and output it to the display unit. The controller 620 controls the column counter 621 and the line counter 622 under the control of the control unit 10, thereby causing the image data to be displayed on the display unit.

The control interface 619 functions as an interface between the image processing unit 70 and the control unit 10, and also functions as an interface between the display unit 80 and the control unit 10. That is, the control interface 619 functions as an interface between the display unit 80 and the image processing unit 70. The control interface 619 is a common interface for accessing registers (not shown) related to the processing settings of the various components within the image processing unit 70, accessing the JPEG buffer and the thumbnail buffer, and accessing the display unit 80 through the image processing unit 70. D<15:0> is data bus, A<1:0> is an address bus, and CS is a select signal of the image processing unit 70 and the display unit 80. WR is a write signal, RD is a read signal, and SEL is a path control signal of the selector 618. INT is a signal notifying control unit 10 of completion of transfer of a frame of data from signal processing unit to LCD T/F 614.

The selector 618 functions to select the data outputted from the image processing unit 70 or the data outputted from the control unit 10 by the path control signal and to output the selected one to the display unit 80. Herein, a first path control signal activates a bus between the image processing unit and the display unit 80 and a second activates a path between the control unit and the display unit 80. This may be achieved by appropriately setting a register (not shown) in control interface 619, the register being addressed by address bus A<2:0>. In addition, the control unit 10 can perform bi-directional communication with the display unit 80 via the selector 618.

Regarding the image processing unit, the operation of the camera 50 for capturing image data and the operation for displaying the captured image data will now be described.

Firstly, it will be described how the image data captured by the camera 50 is transferred to the display unit 80.

The image processing unit 70 controls the transmission rate of the image data outputted from the signal processing unit 60 and stores the inputted image data in the memory of the display unit through the LCD interface 614. The transmission rate of the image data is fixedly determined in reference to a master clock but the flow of the image signal to the signal processing unit 60, the image processing unit 70 and the display unit 80 is limited by the access speed of the display unit 80. Therefore, in order to adjust the read speed of the image signal from the signal processing unit 60 and the write speed of the image signal to the display unit 80, the LCD interface 614 temporarily performs buffering through the line buffer 617.

In the following description, the camera 50 with the afore-mentioned constituent elements will be described assuming that it is mounted in a portable telephone.

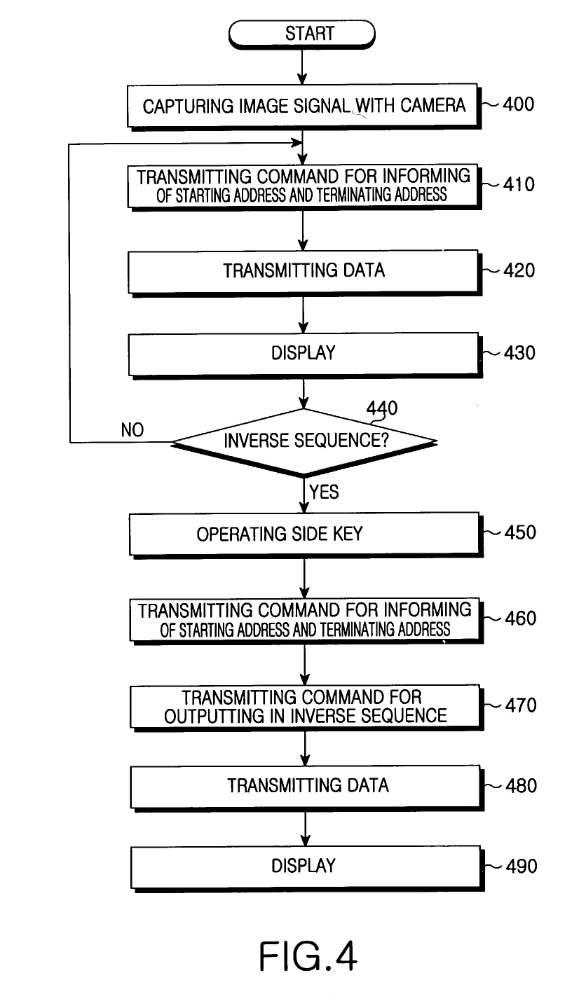

FIG. 4 is a flowchart showing how image data is transferred to the portable telephone in accordance with the present invention.

Hereinafter, the first embodiment of the present invention will be described with reference to FIGS. 1, 3a and 6.

First, the user inputs key data for operating the camera 50 using the key pad 27 in step 400. For this operation, the key for operating the photographing mode may be positioned on a navigation key of the key pad 27 or selected from a menu, which is displayed using a menu key.

The photographing mode is selected as described above and the image signal photographed by the camera 50 is transmitted through the signal processing unit 60 to the image processing unit 70.

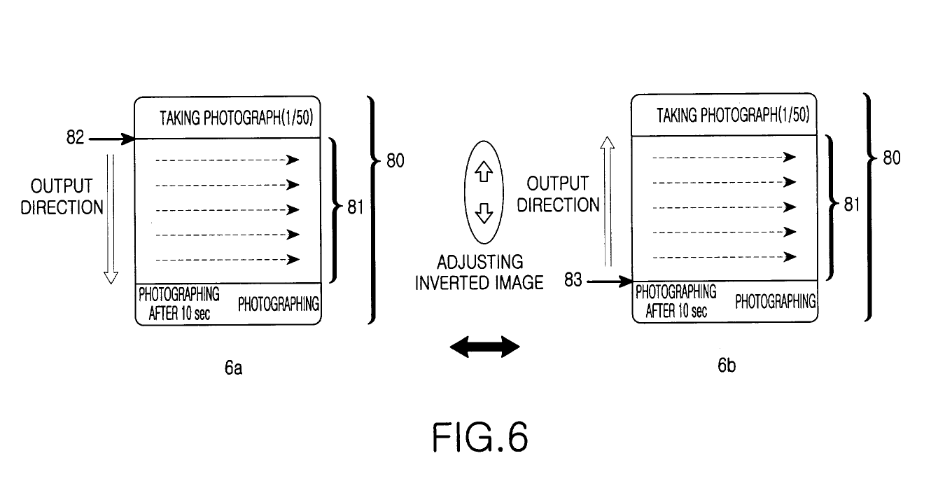

In step 410, the image processing unit 70 transmits a command, which informs the display unit 80 of a starting address and a terminating address of the outputted image data photographed by the camera 50. When the image data photographed by the camera 50 is transmitted to the image processing unit 70 in step 420, it proceeds to step 430, where the image data is outputted from the starting address 82 transmitted by the image processing unit 70 and displayed on the image data display unit 81, as shown in FIG. 6a. If the image data displayed in step 430 is output as an inverted image, the user perceives it in step 440 and proceeds to step 450 where the side key 90 is operated. If the side key 90 is operated in step 450, the control unit 10 controls the image processing unit 70 and transmits a command, which informs the display unit 80 of the starting address and terminating address of the outputted image data in step 460.

After step 460 has been proceeded, the image processing unit 70 transmit a command to the display unit 80 in step 470, so that the outputted image data is outputted in the reversed order. When the image processing unit 70 transmits the image data photographed by the camera 50 to the display unit 80, it proceeds to step 490, where the image data is outputted in the reverse sequence from the changed starting address 83 transmitted by the image processing unit and then displayed on the image data display unit 81, as shown in FIG. 6b.

If the image data outputted to the image data display unit in step 440 is an inverted one having the starting address 82 as shown in FIG. 6a, by the user's operation of the side key, the image data transmitted to the display unit 80 has the starting address 83 as shown in FIG. 6b and the image data is outputted as a non-inverted image.

In another case, if the initial image data outputted to the image data display unit in step 440 is an inverted one having the starting address 83 as shown in FIG. 6b, by the user's operation of the side key, the image data transmitted to the display unit 80 has the starting address 82 as shown in FIG. 6a and the image data is outputted as a non-inverted image.

The process shown in FIG. 4 can output the image data of all of the frames by repeating the above process using the image data of one frame outputted to the display unit 80.

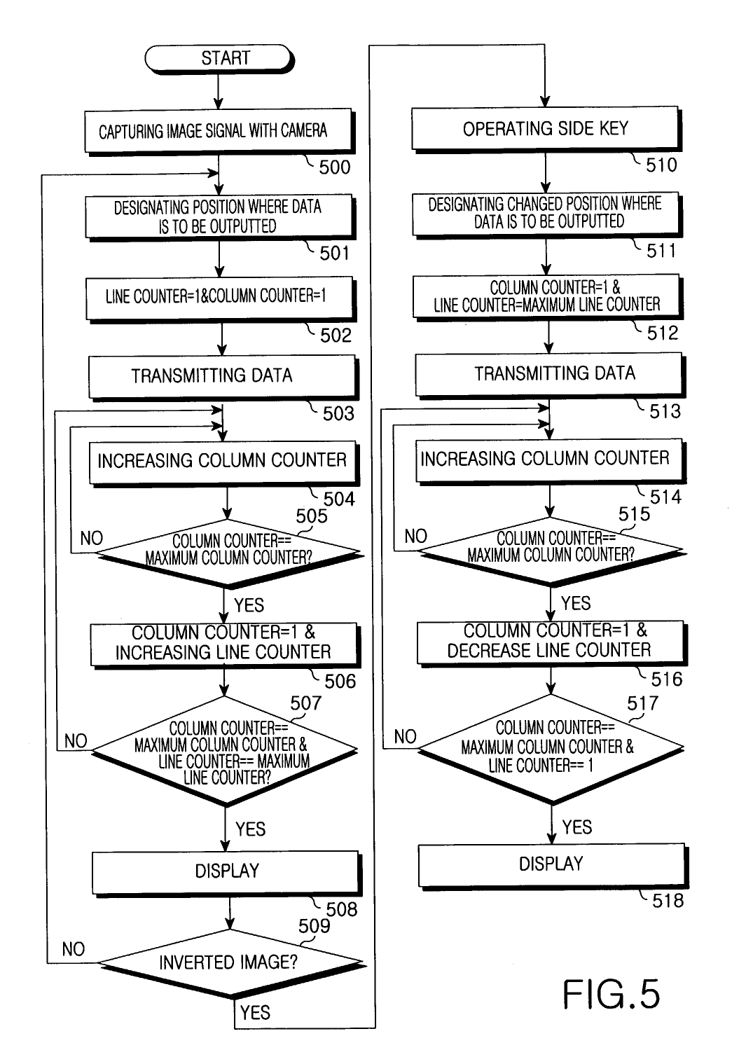

FIG. 5 is a flowchart showing the process for transmitting an image data to the display unit of the portable telephone in accordance with the present invention.

Hereinafter, the second embodiment of the present invention will be described with reference to FIGS. 1, 3b and 6.

At first, the user inputs key data for operating the camera 50 using the key pad 27 in step 500. For this operation, the key for operating the photographing mode may be positioned on a navigation key of the key pad 27 or selected from a menu, which is displayed using a menu key.

The photographing mode is selected as described above and the image signal photographed by the camera 50 is transmitted through the signal processing unit 60 to the image processing unit 70.

In step 501, the image processing unit 70 transmits a starting address 82 to the display unit 80, wherein at the starting address, a positional area value of the image data display unit 81 is output, which shows the extent of prospective image data, and then the image processing unit 70 proceeds to step 502. In step 502, the column counter value and the line counter value are initialized to “1,” and then processing proceeds to step 503, where the image processing unit 70 transmits the image data to the display unit 80. When the image data is transmitted to the display unit 80 in step 503, the column counter 621 increases the counter column value from the starting address 82 and outputs the image data in step 504. If the column counter value is increased and thus the process proceeds to step 505 where the column counter value increases and becomes a maximum value, the process proceeds to step 506, where the line counter 622 increases the line counter value by 1 and the column counter value is set to “1.”

Step 504 to step 506 are repeated until the condition of step 507 is met, where each of the column counter value and the line counter value becomes a maximum value. Then, the outputting of image data is terminated and the process proceeds to step 508, where the image data is outputted to the image data display unit 81, as shown in FIG. 6a.

In addition, if the process proceeds to step 507 where each of the column counter value and the line counter value becomes a maximum value, each of the column counter value and the line counter value is initialized to “1.”

In step 509 it is determined whether the image data outputted to the display unit 80 in step 508 is outputted as inverted one. If the user perceives that the image data has been outputted to the display unit as an inverted image, the user operates the side key 90 in step 510. In step 511, the image processing unit 70 transmits a starting address 83 to the display unit 80, wherein at the starting address, and a prospective positional area value of the image data display unit 81 is output. The image processing unit 70 proceeds to step 512. In step 512, the column counter value is initialized to “1”, the line counter value is initialized to its maximum value, and the processing proceeds to step 513, where the image processing unit 70 transmits the image data to the display unit 80. When the image data is transmitted to the display unit 80 in step 513, the column counter 621 increases the counter column value from the changed starting address 83 and outputs the image data in step 514. If the column counter value is increased and thus the process proceeds to step 515 where the column counter value increases and becomes a maximum value, the process proceeds to step 516, where the line counter 622 reduces the line counter value reduced by 1 and the column counter value is re-established to “1.”

Step 514 to step 516 are repeated. When the condition of step 517 is met, namely where the column counter value becomes a maximum value and the line counter value becomes a minimum value, the outputting of image data is terminated and the process proceeds to step 518, where the image data is outputted to the image data display unit 81, as shown in FIG. 6b.

In addition, if the process proceeds to step 517 where the column counter value becomes a maximum value and the line counter value becomes a minimum value, the column counter value and the line counter value are established to the initial value.

If the image data outputted to the display unit 80 in step 509 is an inverted one having the starting address 83 as shown in FIG. 6b, by the user's operation of the side key, the image data transmitted to the display unit 80 has the starting address 82 as shown in FIG. 6a and the image data can be outputted as a non-inverted image.

The process shown in FIG. 5 can output the image data of all of the frames by repeating the above process using the image data of one frame outputted to the display unit 80.

The present invention, which works as described above in detail, provides an effect among others, which is briefly summarized as follows.

The present invention has an effect that when photographed image data is outputted as an inverted one, the inverted image data can be adjusted by simply operating a key.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An image display system for a portable telephone comprising:
a key pad provided with keys for setting a photographing mode and a screen displaying mode;
a camera for capturing an image signal;
a signal processing unit for converting the image signal outputted from the camera into an image data;
a display unit for displaying the image data received from the signal processing unit;
a side key for displaying the image data as an inverted image on the display unit;
an image processing unit for transmitting the image data received from the signal processing unit and a starting address value where the image data starts to the display unit, wherein the image processing unit changes the address value where the image data starts and transmits it to the display unit when the side key is inputted; and
a control unit for generating a photographing control signal at the time when the photographing mode key is inputted, wherein the control unit commands the image processing unit to change the starting address value where the image data starts to be outputted and to transmit it to the display unit when the side key is inputted.

2. The image display system according to claim 1, wherein the image processing unit comprises:
a column counter for generating an address in the column direction in the display unit;
a line counter for generating an address in the line direction in the display unit; and
a controller for controlling the column counter and the line counter.

3. A method for displaying an image in a portable telephone comprising the steps of:
capturing an image with a camera;
transmitting a command, which informs a display unit of a starting address of the image data, which is outputted;
transmitting the image data captured by the camera;
outputting the image data to the display unit from the starting address;
judging whether the image data outputted to the display unit is displayed as an inverted image;
operating a side key when the image data outputted to the display unit is displayed as an inverted image;
transmitting a command, which informs the display unit of a revised starting address of the image data which is outputted;
transmitting a command such that the image data is outputted in an inverted sequence;
transmitting the image data captured by the camera; and
outputting the image data from the revised starting address in the inverted sequence.

4. A method for displaying an image in a portable telephone comprising the steps of:
capturing an image with a camera;
designating a starting address of the image data outputted to a display unit;
initializing a column counter value and a line counter value;
transmitting the image data captured by camera to the display by increasing the column counter value until the column counter becomes a maximum value, and increasing the line counter value by one and re-initializing the column counter when the column counter value becomes a maximum value, wherein this procedure is repeated until both of the column counter value and the line counter value become maximum values;
initializing the column counter value and the line counter value and terminating the outputting of the image data and displaying the image data in the display unit when both of them become maximum values;
judging whether the image data outputted to the display unit is displayed as an inverted image;
operating a side key when the image data outputted to the display unit is displayed as an inverted image;
changing and designating the starting address of the image data outputted to the display unit;
initializing the column counter value to a minimum value and the line counter value to a maximum value;
transmitting the image data captured by the camera to the display by increasing the column counter value until the column counter becomes a maximum value, and decreasing the line counter value by one and re-initializing the column counter when the column counter value becomes the maximum value, wherein this procedure is repeated until the column counter value becomes the maximum value and the line counter value becomes the minimum value; and
initializing the column counter value and the line counter value, terminating the outputting of the image data and displaying image data on the display unit when the column counter value becomes the maximum value and the line counter value becomes the minimum value.

5. The system according to claim 1, wherein the display unit comprises an image data display unit, to which the image data is outputted, and the starting address for outputting the image data is present in the image data display unit.

6. The system according to claim 2, wherein the display unit comprises an image data display unit, to which the image data is outputted, and the starting address for outputting the image data is present in the image data display unit.

7. The method according to claim 3, wherein the display unit comprises an image data display unit, to which the image data is outputted, and the starting address for outputting the image data is present in the image data display unit.

8. The method according to claim 4, wherein the display unit comprises an image data display unit, to which the image data is outputted, and the starting address for outputting the image data is present in the image data display unit.
